(19) United States
(12) Patent Application Publication
(10) Pub. No.: US 2004/0013481 A1
(43) Pub. Date: Jan. 22, 2004

(54) Grommet remover tool

(76) Inventor: Richard F. Jeppesen, Howie-in-the-Hills, FL (US)

Correspondence Address: Edward M. Livingston, Esq., 628 Ellen Dr., P.O. Box 1599, Winter Park, FL, 32790, US

(21) Appl. No.: 10/197,915

(22) Filed: Jul. 17, 2002

(51) Int. Cl. B23B 51/00

(52) U.S. Cl. 408/201

(57) ABSTRACT

A grommet-remover tool has a grommet-flange cutter (1) with a cylindrical cutting surface (2) that is articulated to cut through a grommet flange (3) proximate a connection of the grommet flange to a grommet sleeve (4) with minimal, if any, cutter grasping of the grommet flange and rotating the grommet in a grommet aperture in covering material (8) to which the grommet is affixed. The grommet-flange cutter includes an attachment boss (6) with which it is attachable to a rotational tool (7).

### BACKGROUND OF THE INVENTION

This invention relates to tools for cutting flanges from fastener grommets to remove the grommets from covering material to which the grommets are affixed for fastening the covering material to implements that include, but are not limited to, aircraft, boats, cars, canvas and sheet metal.

Previously, when removing grommets of covering material from propeller airplanes, race cars and other implements for repair and replacement, a common practice has been to pound and pry the grommet sleeves and flanges with various general-purpose pounding and prying tools that often damaged the sheets, the vehicles and implements to which the grommets were affixed. In addition to likelihood of damage, this has also been a time-consuming chore, requiring a half hour to a full hour for removing each grommet. There has been no known tool for removing grommets quickly, safely and conveniently in a manner taught by this invention.

Examples of most-closely related known but different devices are described in the following patent documents:

| Pat. No. | | |
|---|---|---|
| (U.S. unless stated otherwise) | Inventor | Issue Date |
| 5,697,935 | Moran, et al. | Dec. 16, 1997 |
| 1,494,897 | Freye | May 20, 1924 |
| 3,950,111 | Churchwell, et al. | Apr. 13, 1976 |
| 1,848,590 | Willis | Mar. 8, 1932 |
| RU 2007282 | Grebeshkov | Feb. 15, 1994 |
| 3,765,789 | Hougen | Oct. 16, 1973 |
| 6,123,490 | Underhill | Sep. 26, 2000 |
| 5,865,834 | McGuire | Feb. 2, 1999 |

Hole-cutter tools with cylindrical sleeve blades as described generally in the prior art referenced above do not provide grommet centering of a cylindrical cutter that is articulated to cut away a grommet flange without rotating or excessively rotating the grommet sleeve in an aperture in which the grommet sleeve is affixed to covering material on aircraft, race cars and implements. Without a cutter being centered effectively over a grommet sleeve, which is not possible with a conventional centering pin, the cylindrical cutter can damage the covering material and a vehicle or implement to which it is affixed. Without articulating the cylindrical cutter to cut predetermined grommet material for cutting away the grommet flange, the grommet will have a tendency to rotate excessively in the aperture in which it is affixed in the covering material.

### SUMMARY OF THE INVENTION

Objects of patentable novelty and utility taught by this invention, therefore, are to provide a grommet-remover tool which:

centers a cylindrical cutter in a grommet sleeve for cutting away a grommet flange that is extended radially from the grommet sleeve; and

is articulated to cut away the grommet flange without grasping and rotating the grommet in an aperture in covering material.

This invention accomplishes these and other objectives with a grommet-remover tool having a circular-sleeve cutter that is articulated to cut through a grommet flange proximate a connection of the grommet flange to a grommet sleeve without the circular-sleeve cutter grasping the grommet flange and rotating the grommet excessively in a grommet aperture in covering material to which the grommet is affixed. The circular-sleeve cutter includes an attachment boss with which it is attachable to a rotational cutting tool.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a top view of a grommet-flange cutter;

FIG. 2 is a partially cutaway side elevation view of the FIG. 1 illustration and showing positive-rake metal-cutting teeth;

FIG. 3 is a bottom view of the FIG. 2 illustration;

FIG. 4 is the FIG. 2 grommet-flange cutter mounted in a representation of a rotational tool that can be electrically, pneumatically, hydraulically or manually operated;

FIG. 5 is a partially cutaway fragmentary side elevation view of a grommet positioned in material and positioned for removal by the grommet-remover tool;

FIG. 6 is a partially cutaway fragmentary top view of the FIG. 5 illustration;

FIG. 7 is a fragmentary side elevation view of the grommet-flange cutter having negative-rake metal-cutting teeth;

FIG. 8 is a fragmentary side elevation view of the grommet-flange cutter having positive-negative-rake metal-cutting teeth;

FIG. 9 is an enlarged fragmentary view of the positive-negative-rake metal-cutting teeth shown in FIG. 8;

FIG. 10 is a cutter-end view of the grommet-flange cutter having metal-grinding particles as an option to metal-cutting teeth;

FIG. 11 is a partially cutaway fragmentary side elevation view of the grommet-flange cutter having a cutter guide that includes tapered cutting surfaces on the grommet-flange cutter with positive-rake metal-cutting teeth that are representative of metal-cutting teeth generally;

FIG. 12 is a cutter-end view of the FIG. 11 illustration;

FIG. 13 is a partially cutaway fragmentary side elevation view of the grommet-flange cutter having a cutter guide that includes tapered cutting surfaces on the grommet-flange cutter with metal-grinding particles that are representative of metal-grinding particles that include diamond, zirconium, stone and fabricated grinding particles; and

FIG. 14 is a cutter-end view of the FIG. 13 illustration.

### DESCRIPTION OF PREFERRED EMBODIMENT

Listed numerically below with reference to the drawings are terms used to describe features of this invention. These terms and numbers assigned to them designate the same features throughout this description.

```
  1. Grommet-flange cutter
  2. Cutting surface
  3. Grommet flange
  4. Grommet sleeve
  5. Centering member
  6. Attachment boss
  7. Rotational tool
  8. Material
  9. Keeper
10. Metal-cutting teeth
11. Leading edge
12. Following edge
13. Metal-grinding particles
14. Tapered cutting surface
```

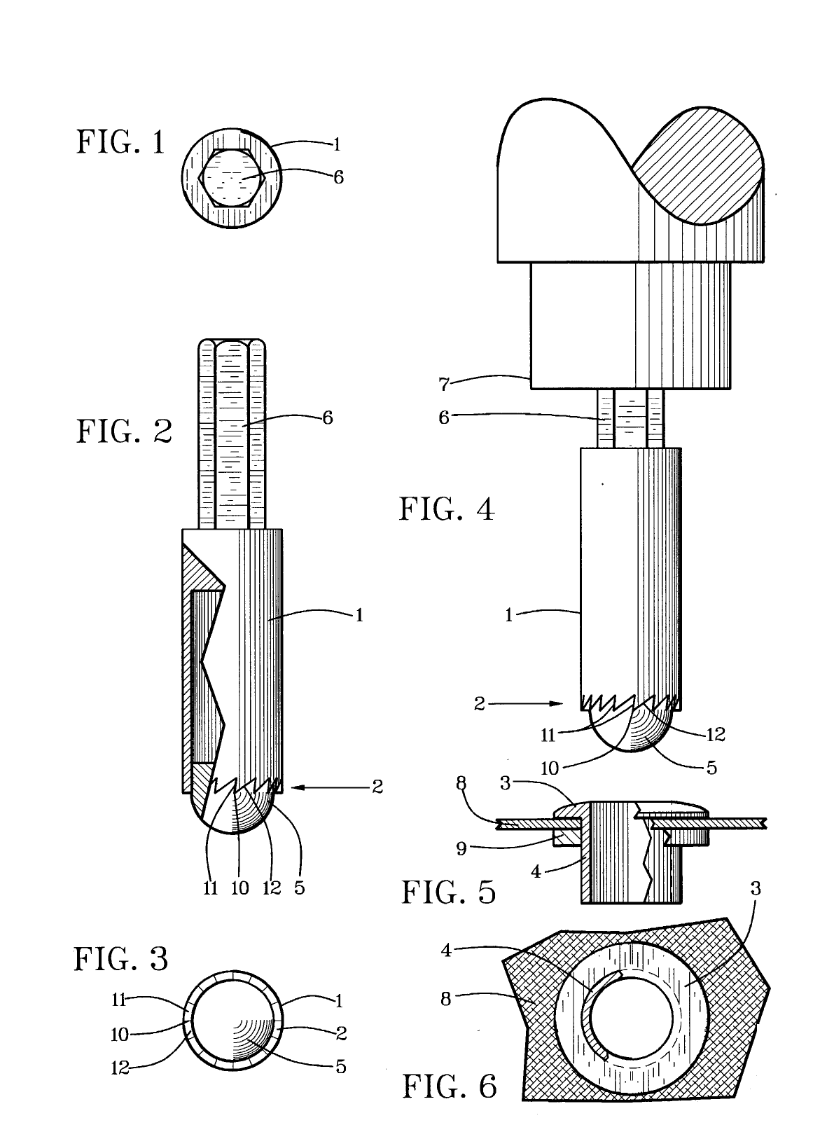

Referring to FIGS. 1-6 of the drawings, the grommet-remover tool includes a grommet-flange cutter 1 having a cutting surface 2 that is articulated to cut through a grommet flange 3 proximate an extension of the grommet flange 3 from a grommet sleeve 4. A cutter guide that can include a centering member 5 on the grommet-flange cutter 1 is articulated for positioning the cutting surface 2 in a predetermined cutting alignment with the grommet flange 3. The centering member 5 is preferably dome shaped and extended collinearly intermediate circumferentially inside walls of the cutting cylinder. It is concentric with an axis of the cutting cylinder and is extended a predetermined distance beyond the cutting surface 2. An attachment boss 6 is extended concentrically from the grommet-flange cutter 1 for attachment to a rotational tool 7 that can be electrically, pneumatically, hydraulically or manually operated.

The cutting surface 2 can include metal-cutting teeth or grinding particles arranged circumferentially on a cutting end that is oppositely disposed from the attachment boss 6 at an attachment end of a cutting cylinder. The attachment boss 6 can be orthogonal to the cutting end and concentrically collinear to the cutting cylinder.

Removal of the grommet is accomplished by cutting through the grommet flange 3 to the grommet sleeve 4 of a grommet in a grommet aperture of material 8 to which the grommet is affixed. Generally, the material 8 is juxtaposed between the grommet flange 3 and a keeper 9 before being removed for repair, replacement or maintenance related to the material 8 and a vehicle or implement to which the material 8 is attached by use of a grommet with typically a Dzus® fastener.

As shown in FIGS. 2, 4 and 11, the metal-cutting teeth 10 of the cutting surface 2 can include a positive rake having ninety or less degrees between a leading edge 11 and a following edge 12 in a circumferential direction of a cutting rotation of the grommet-flange cutter 1 by rotation of the attachment boss 6 in the circumferential direction of the cutting rotation with the rotational tool 7.

The metal-cutting teeth 10 can be straight without side slant for chip removal because there is only single-side cutting and chips can travel laterally into the grommet sleeve 4.

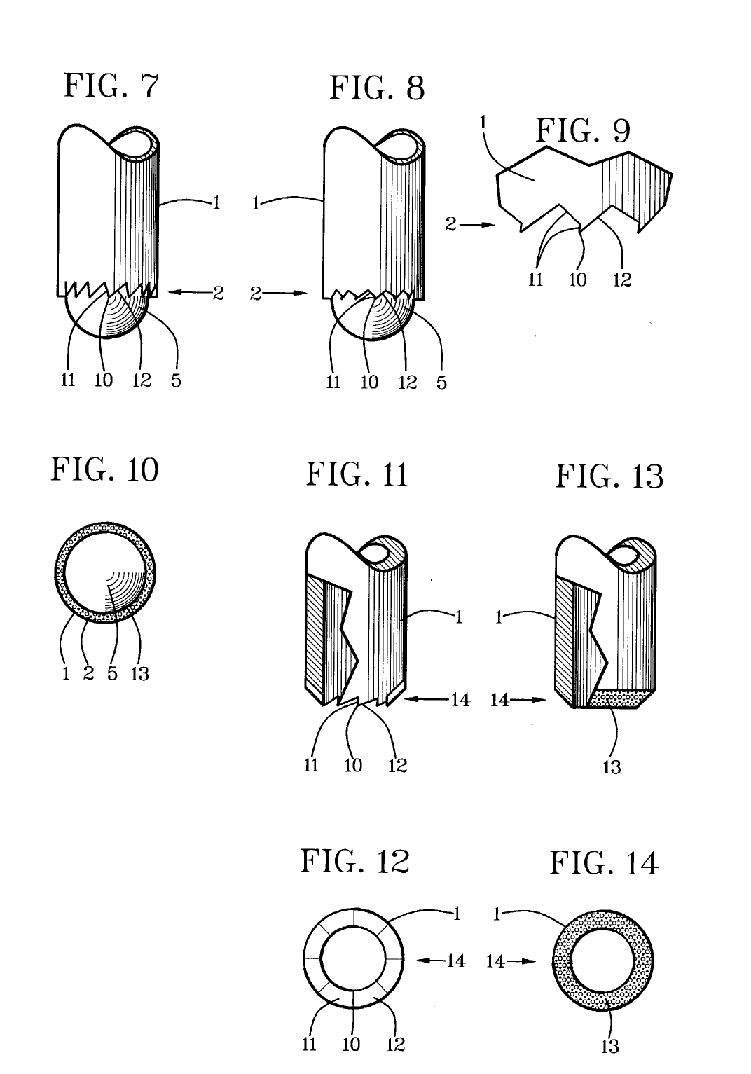

Referring to FIGS. 7-14, the metal-cutting teeth 10 can include a negative rake with more than ninety degrees between the leading edge 11 and the following edge 12 as shown in FIG. 7. Also, the metal-cutting teeth 10 can include a positive-negative rake having a positive rake for cutting contact with the grommet flange 3 and having a negative rake starting a predetermined cut-depth distance collinearly from the positive rake as shown in FIGS. 8-9. The cut-depth distance of the positive-negative rake is predetermined to assure predeterminedly shallow positive-rake cutting depths.

As shown in FIGS. 10 and 13-14, the cutting surface 2 can include metal-grinding particles 13 arranged circumferentially on the cutting end of the cutting cylinder of the grommet-flange cutter 1.

The metal-grinding particles 13 are selected from a class of metal-grinding particles that include diamond, zirconium, stone and fabricated grinding particles.

As depicted in FIGS. 11-14, the cutter guide can include a tapered cutting surface 14 of the grommet-flange cutter 1 that is tapered centrally for positioning the cutting surface in a predetermined cutting alignment with the grommet flange 3 and the grommet sleeve 4. Optionally, the tapered cutting surface 14 can have the metal-cutting teeth 10 as shown in FIGS. 11-12 or the metal-grinding particles 13 as shown in FIGS. 13-14.

Rotation of the grommet from rotational cutting with the grommet-flange cutter 1 can be prevented by grasping the grommet sleeve 4 or the grommet flange 3 with a plier-like tool if necessary.

Grommets are made of metallic or other rigid material that be cut with the metal-cutting teeth 10 or the metal-grinding particles 13 on the cutting surface 2 for removal with this grommet-remover tool.

This invention can be used also as a hole-enlargement tool.

A new and useful grommet-remover tool having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A grommet-remover tool comprising
a grommet-flange cutter;
a cutting surface on the grommet-flange cutter that is articulated to cut through a grommet flange proximate an extension of the grommet flange from a grommet sleeve;
a cutter guide articulated on the grommet-flange cutter for positioning the cutting surface in a predetermined cutting alignment with the grommet flange; and
an attachment boss extended concentrically from the grommet-flange cutter for attachment to a rotational tool.

2. The grommet-remover tool of claim 1 wherein:
the cutting surface on the grommet-flange cutter includes metal-cutting teeth arranged circumferentially on a cutting end of a cutting cylinder;
the cutting end being oppositely disposed from an attachment end of the cutting cylinder; and
the attachment boss is orthogonal to the cutting end and concentrically collinear to the cutting cylinder.

3. The grommet-remover tool of claim 2 wherein:
the metal-cutting teeth include a positive rake in a circumferential direction of a cutting rotation of the cutting cylinder by rotation of the attachment boss in the circumferential direction of the cutting rotation with a rotational tool.

4. The grommet-remover tool of claim 2 wherein:
the cutter guide includes a centering member that is extended collinearly intermediate circumferentially inside walls of the cutting cylinder;
the centering member includes an axis that is concentric with an axis of the cutting cylinder; and
the centering member is extended a predetermined distance beyond the cutting surface and opposite the attachment boss.

5. The grommet-remover tool of claim 4 wherein:
the centering member is domed to provide line contact with an inside periphery of the grommet sleeve while the cutting sleeve is being rotated.

6. The grommet-remover tool of claim 2 wherein:
the metal-cutting teeth include a negative rake in a circumferential direction of the cutting rotation of the cutting cylinder by rotation of the attachment boss in the circumferential direction of the cutting rotation with the rotational tool.

7. The grommet-remover tool of claim 2 wherein:
the metal-cutting teeth include a positive-negative rake in a circumferential direction of the cutting rotation of the cutting cylinder by rotation of the attachment boss in the circumferential direction of the cutting rotation with the rotational tool; and
the positive-negative rake having a positive rake for cutting contact with the grommet flange and having a negative rake starting a predetermined cut-depth distance collinearly and axially from the positive rake.

8. The grommet-remover tool of claim 7 wherein:
the cut-depth distance is predetermined to assure predeterminedly shallow positive-rake cutting depths.

9. The grommet-remover tool of claim 2 wherein:
the metal-cutting teeth are straight without side slant for chip removal.

10. The grommet-remover tool of claim 1 wherein:
the cutting surface on the grommet-flange cutter includes metal-grinding particles arranged circumferentially on the cutting end of the cutting cylinder;
the cutting end being oppositely disposed from an attachment end of the cutting cylinder; and
the attachment boss is orthogonal to the cutting end and concentrically collinear to the cutting cylinder.

11. The grommet-remover tool of claim 10 wherein:
the cutter guide includes a centering member that is extended collinearly intermediate circumferentially inside walls of the cutting cylinder;
the centering member includes an axis that is concentric with an axis of the cutting cylinder; and
the centering member is extended a predetermined distance beyond the cutting surface and opposite the attachment boss.

12. The grommet-remover tool of claim 11 wherein:
the centering member is domed to provide line contact with an inside periphery of the grommet sleeve while the cutting sleeve is being rotated.

13. The grommet-remover tool of claim 10 wherein:
the metal-grinding particles are selected from a class of metal-grinding particles that include diamond, zirconium, stone and fabricated grinding particles.

14. The grommet-remover tool of claim 1 wherein:
the cutter guide includes a tapered cutting surface of the grommet-flange cutter that is tapered centrally for positioning the cutting surface in a predetermined cutting alignment with the grommet flange.

15. The grommet-remover tool of claim 14 wherein:
the tapered cutting surface on the grommet-flange cutter includes metal-cutting teeth arranged circumferentially on a cutting end of a cutting cylinder;
the cutting end being oppositely disposed from an attachment end of the cutting cylinder; and
the attachment boss is orthogonal to the cutting end and concentrically collinear to the cutting cylinder.

16. The grommet-remover tool of claim 15 wherein:
the metal-cutting teeth include a positive rake in a circumferential direction of a cutting rotation of the cutting cylinder by rotation of the attachment boss in the circumferential direction of the cutting rotation with a rotational tool.

17. The grommet-remover tool of claim 15 wherein:
the metal-cutting teeth include a negative rake in a circumferential direction of the cutting rotation of the cutting cylinder by rotation of the attachment boss in the circumferential direction of the cutting rotation with the rotational tool.

18. The grommet-remover tool of claim 15 wherein:
the metal-cutting teeth include a positive-negative rake in a circumferential direction of the cutting rotation of the cutting cylinder by rotation of the attachment boss in the circumferential direction of the cutting rotation with the rotational tool; and
the positive-negative rake having a positive rake for cutting contact with the grommet flange and having a negative rake starting a predetermined cut-depth distance collinearly and axially from the positive rake.

19. The grommet-remover tool of claim 18 wherein:
the cut-depth distance is predetermined to assure predeterminedly shallow positive-rake cutting depths.

20. The grommet-remover tool of claim 15 wherein:
the cutting surface on the grommet-flange cutter includes metal-grinding particles arranged circumferentially on the cutting end of the cutting cylinder;
the cutting end being oppositely disposed from an attachment end of the cutting cylinder; and
the attachment boss is orthogonal to the cutting end and concentrically collinear to the cutting cylinder.

21. A grommet-remover tool comprising
a grommet-flange cutter;
a cutting surface on the grommet-flange cutter that is articulated to cut through a grommet flange proximate an extension of the grommet flange from a grommet sleeve;
a cutter guide articulated on the grommet-flange cutter for positioning the cutting surface in a predetermined cutting alignment with the grommet flange;
an attachment boss extended concentrically from the grommet-flange cutter for attachment to a rotational tool;
the cutting surface on the grommet-flange cutter includes metal-cutting teeth arranged circumferentially on a cutting end of a cutting cylinder;
the cutting end being oppositely disposed from an attachment end of the cutting cylinder;
the attachment boss is orthogonal to the cutting end and concentrically collinear to the cutting cylinder;
the cutter guide includes a centering member that is extended collinearly intermediate circumferentially inside walls of the cutting cylinder;
the centering member includes an axis that is concentric with an axis of the cutting cylinder;
the centering member is extended a predetermined distance beyond the cutting surface and opposite the attachment boss; and
the centering member is domed to provide line contact with an inside periphery of the grommet sleeve while the cutting sleeve is being rotated.

22. A grommet-remover tool comprising
a grommet-flange cutter;
a cutting surface on the grommet-flange cutter that is articulated to cut through a grommet flange proximate an extension of the grommet flange from a grommet sleeve;
a cutter guide articulated on the grommet-flange cutter for positioning the cutting surface in a predetermined cutting alignment with the grommet flange;
the cutter guide including a tapered cutting surface of the grommet-flange cutter that is tapered centrally for positioning the cutting surface in a predetermined cutting alignment with the grommet flange; and
an attachment boss extended concentrically from the grommet-flange cutter for attachment to a rotational tool.
